(19) United States
(12) Patent Application Publication
(10) Pub. No.: US 2012/0249085 A1
(43) Pub. Date: Oct. 4, 2012

(54) Method For Controlling Charging Current

(75) Inventors: Chia-Hsiang Lin, Taipei City (TW); Li-Wei Lee, New Taipei City (TW); Chen-Hsiang Hsiao, Taoyuan County (TW); Hsuan-Kai Wang, New Taipei City (TW)

(73) Assignee: RICHTEK TECHNOLOGY CORP, Hsinchu County (TW)

(21) Appl. No.: 13/181,643

(22) Filed: Jul. 13, 2011

(30) Foreign Application Priority Data
Apr. 1, 2011 (TW) 100111619

(51) Int. Cl. H02J 7/04

(52) U.S. Cl. 320/162

(57) ABSTRACT

An exemplary method for controlling a charging current is adapted to a charging device. The charging device receives an input voltage to thereby output the charging current. The method includes the following steps of: making the charging current have a first value; judging whether the input voltage is less than a preset reference voltage; and if the input voltage is judged to be less than the preset reference voltage, decreasing the charging current from the first value step by step until the input voltage retrieves back above the preset reference voltage.

### TECHNICAL FIELD

The disclosure generally relates to charging control technologies and, particularly to a method for controlling a charging current.

### BACKGROUND

A charging device for portable electronic device is generally provided with electrical power (i.e., is provided with an input voltage) through an adaptor or a universal serial bus (USB) power source, so as to provide a charging current for charging the electronic device. It is known that the USB power source generally has an output current limit, for example 100 mA or 500 mA. If the charging current is higher than the USB power source ability, the input voltage is crashed down. Under such an over-charging current situation, a conventional charging device will be turned off because of input under-voltage protection. Once the charging current is less than the current limit, the input voltage retrieves back to its normal/regular value and the charging process resumes. The above-described abnormal situation obviously affects the whole charging operation and terminates the charging process, resulting in a lower charging efficiency.

Therefore, how to avoid the unexpected termination of charging process caused by the over-charging current in the prior art so as to improve the charging efficiency is an urgent topic needed to be solved.

### SUMMARY OF EMBODIMENTS

Accordingly, the disclosure is directed to a method for controlling a charging current, so as to achieve a relatively higher charging efficiency.

More specifically, a method for controlling a charging current in accordance with an embodiment is adapted to a charging device. The charging device receives an input voltage to thereby output the charging current. In the present embodiment, the method for controlling a charging current includes the following steps of: making the charging current have a first value; judging whether the input voltage is less than a preset reference voltage; and if the input voltage is judged to be less than the preset reference voltage, decreasing the charging current from the first value step by step until the input voltage retrieves back above the preset reference voltage.

A method for controlling a charging current in accordance with another embodiment is adapted to a charging device. The charging device receives an input voltage to thereby output the charging current. In the present embodiment, the method for controlling a charging current includes the following steps of: making the charging current increase from an initial value step by step; and after the charging current is increased with each step, judging whether the input voltage is less than a preset reference voltage; if the input voltage is judged to be less than the preset reference voltage, making the charging current retrieve back to a previous value; and if the input voltage is judged to be not less than the preset reference voltage, making the charging current continue increasing by step.

A method for controlling a charging current in accordance with still another embodiment includes the following steps of: detecting a value of the charging current; and when the detected value of the charging current is greater than a current limit value, outputting a pulse signal to control the charging current to be decreased. Herein, a pulse width of the pulse signal determines the decreased value of the charging current.

In summary, the various embodiments of the present disclosure dynamically control the charging current. On one hand, when the input voltage quickly drops caused by over-charging current, the charging current can be appropriately decreased to make the input voltage retrieve back to its normal/regular value, which can avoid terminating the charging process occurred in the prior art. On the other hand, the charging current can be increased as high as possible on the prerequisite of that the input voltage is not less than the preset reference voltage, so that a relatively higher charging efficiency compared with the prior art can be achieved.

Other objectives, features and advantages of the present disclosure will be further understood from the further technological features disclosed by the embodiments of the present disclosure wherein there are shown and described preferred embodiments of this invention, simply by way of illustration of modes best suited to carry out the invention.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a schematic circuit diagram of a charging device adapted to a method for controlling a charging current in accordance with an exemplary embodiment,

FIG. 2A shows a flow chart of increasing a charging current in a method for controlling the charging current in accordance with an exemplary embodiment,

FIG. 2B shows a flow chart of decreasing a charging current in a method for controlling the charging current in accordance with an exemplary embodiment,

FIG. 3A shows a waveform diagram associated with a method for controlling a charging current in accordance with an exemplary embodiment, and

FIG. 3B shows a waveform diagram associated with a method for controlling a charging current in accordance with another exemplary embodiment.

### DETAILED DESCRIPTION

In the following detailed description of the embodiments, reference is made to the accompanying drawings which form a part hereof, and in which are shown by way of illustration specific embodiments in which the disclosure may be practiced. It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Accordingly, the descriptions will be regarded as illustrative in nature and not as restrictive.

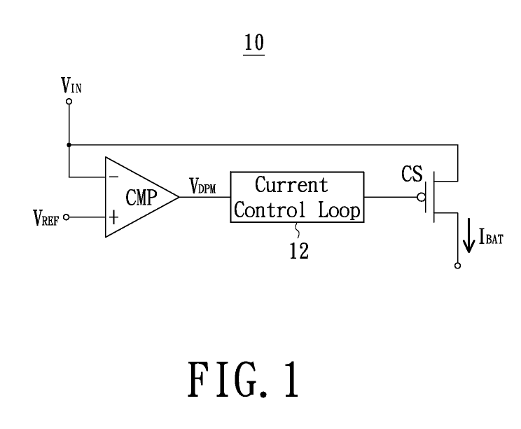

Referring to FIG. 1, FIG. 1 shows a schematic circuit diagram of a charging device adapted to a method for controlling a charging current in accordance with an exemplary embodiment. As shown in FIG. 1, the charging device 10 includes a comparator CMP, a current control loop 12, and a charging switch CS. The charging device 10 is adapted to receive an input voltage V_{IN} from an external power source for example a USB power source with current limit to thereby output the charging current I_{BAT} for charging an electronic device for example, mobile phone or camera.

More specifically, a negative input terminal of the comparator CMP receives the input voltage V_{IN}, and a positive input terminal of the comparator CMP receives a reference voltage V_{REF}. The comparator CMP outputs a pulse signal V_{DPM} according to the relative magnitude relationship between the received input voltage V_{IN} and the reference voltage V_{REF}. The current control loop 12 is electrically coupled between the comparator CMP and a control terminal of the charging switch CS, for controlling a working state of the charging switch CS to set the value of the charging current I_{BAT,} and further is controlled by the pulse signal V_{DPM} to determine a decreased amount of the charging current I_{BAT}. The charging switch CS is electrically coupled to the comparator CMP to receive the input voltage V_{IN}, and is controlled by the current control loop 12 to provide the charging current I_{BAT} for charging a rechargeable battery of the electronic device. It can be found from FIG. 1 that the comparator CMP is used to detect the input voltage V_{IN} and the charging current I_{BAT}. When the input voltage V_{IN} is less than the reference voltage V_{REF} and correspondingly the charging current I_{BAT} is greater than the current limit value of the external power source, the comparator CMP generates the pulse signal V_{DPM} (corresponding to the comparator CMP outputting a logic high voltage level) to control the current control loop 12 so as to decrease the charging current I_{BAT}.

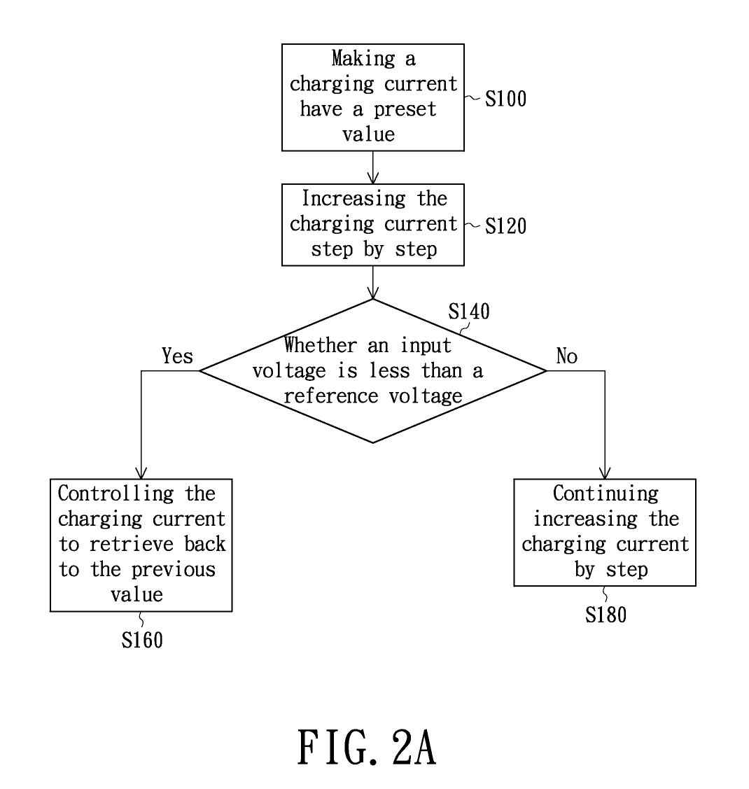

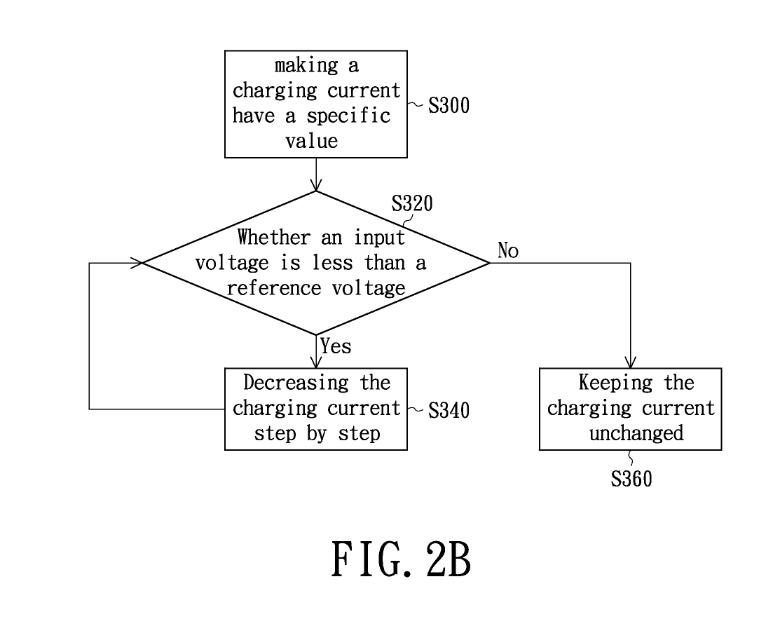

Referring to FIG. 1 and FIG. 2A together, FIG. 2A shows a flow chart of increasing a charging current in a method for controlling a charging current in accordance with an exemplary embodiment. As shown in FIG. 2A, firstly, the charging current I_{BAT} is made to have a preset value (step S100) for example, an initial value of the charging current when a charging operation just begins. Subsequently, the charging current I_{BAT} is increased step by step (step S120). After the charging current I_{BAT} is increased with each step, the input voltage V_{IN} is judged whether less than the reference voltage V_{REF} (step S140). If the judging result is YES, which indicates that the charging current I_{BAT} is greater than the current limit value, the charging current I_{BAT} is controlled to retrieve back to the previous value (S160). If the judging result is NO, which indicates that the charging current I_{BAT} is not greater than the current limit value, the charging current I_{BAT} is controlled to continue increasing by step (step S180), and then the process goes back to step S140. It can be found from FIG. 2A that the charging current I_{BAT} increases step by step from an initial value to a target value, in order to maximize the charging current I_{BAT} and thereby achieve a higher charging efficiency.

Referring to FIG. 1 and FIG. 2B, FIG. 2B shows a flow chart of decreasing a charging current in a method for controlling the charging current in accordance with an exemplary embodiment. As shown in FIG. 2B, the charging current I_{BAT} is made to have a specific value (step S300), herein, the specific value for example is the charging current target value obtained by performing the process in FIG. 2A or a current value greater than the current limit value. The input voltage V_{IN} then is judged whether less than the reference voltage V_{REF} (step S320). If the judging result is YES, which indicates the charging current I_{BAT} is greater than the current limit value, the charging current I_{BAT} correspondingly is controlled to decrease by step (step 5340) and the process goes back to step S320. If the judging result is NO, which indicates the charging current I_{BAT} is not greater than the current limit value, the charging current I_{BAT} is maintained unchanged (step S360). It can be found from FIG. 2B that when the charging current I_{BAT} is greater than the current limit value, the charging current I_{BAT} in the present embodiment is controlled to decrease step by step rather than is closed like the prior art, so that the charging efficiency can be improved consequently.

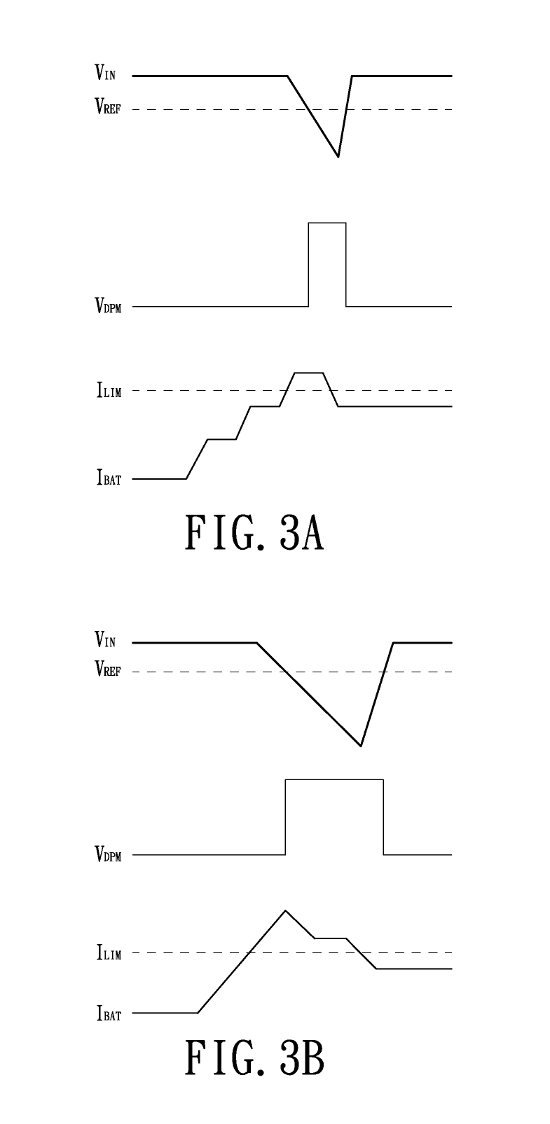

Referring to FIG. 1 and FIG. 3A, FIG. 3A shows a waveform diagram associated with a method for controlling a charging current in accordance with an exemplary embodiment. In FIG. 3A, the charging current I_{BAT} increases step by step using the method as shown in FIG. 2A until the charging current I_{BAT} is greater than the current limit value I_{LIM} It can be found from FIG. 3A that after the charging current I_{BAT} step by step increases with three equal steps, because the charging current I_{BAT} has been greater than the current limit value I_{LIM}, the input voltage V_{IN} drops quickly to be less than the reference voltage V_{REF}, the comparator CMP correspondingly generates the pulse signal V_{DPM} (corresponding to the comparator CMP outputs a logic high voltage level) to trigger the current control loop 12 to decrease the charging current I_{BAT} with one step in the manner of step by step. Because the decreased charging current I_{BAT} no longer exceeds the current limit value I_{LIM}, the input voltage V_{IN} retrieves back above the reference voltage V_{REF} and the output of the comparator CMP changes to be a logic low voltage level, so that the pulse signal V_{DPM} stops being outputted. After that, the charging current I_{BAT} maintains at the decreased value for charging operation. Understandably, the charging current I_{BAT} is not limited to be increased using the above-mentioned equal-step method, it can also be increased using an unequal-step method, such as step values decrease in turn.

Referring to FIG. 1 and FIG. 3B, FIG. 3B shows a waveform diagram associated with a method for controlling a charging current in accordance with another exemplary embodiment. In FIG. 3B, the charging current I_{BAT} is increased using a linear method until greater than the current limit value I_{LIM.} It can be found from FIG. 3B that after the charging current I_{BAT} increases using a linear method to be greater than the current limit value I_{LIM}, the input voltage V_{IN} drops quickly to be less than the reference voltage V_{REF}. The comparator CMP correspondingly generates the pulse signal V_{DPM} (corresponding to the comparator CMP outputs a logic high voltage level) to trigger the current control loop 12 to decrease the charging current I_{BAT} step by step for example as shown in FIG. 2B. When the charging current I_{BAT} step by step decreases with two equal steps, the decreased charging current I_{BAT} does not exceed the current limit value I_{LIM}, and the input voltage V_{IN} retrieves back to be greater than the reference voltage V_{REF}. So that the output of the comparator CMP changes to a logic low voltage level and the pulse signal V_{DPM} stops being outputted as a result. After that, the charging current I_{BAT} keeps at the decreased value for charging operation. Understandably, the charging current I_{BAT} is not limited to be decreased using the above-mentioned equal-step method, it can also be decreased using an unequal-step method, such as step values decrease in turn.

In addition, by comparing FIG. 3A with FIG. 3B, it can be found that the pulse width of the pulse signal V_{DPM} determines the decreased value of the charging current I_{BAT}. For example, since the pulse width of the pulse signal V_{DPM} as shown in FIG. 3A is shorter than the pulse width of the pulse signal V_{DPM} as shown in FIG. 3B, so that the decreased step amount of the charging current I_{BAT} as shown in FIG. 3A is less than the deceased step amount of the charging current I_{BAT} as shown in FIG. 3B correspondingly.

Sum up, the present disclosure dynamically controls the charging current. On one hand, when the input voltage quickly drops caused by over-charging current, the charging current can be appropriately decreased to make the input voltage retrieve back to its normal/regular value, which can avoid terminating the charging process occurred in the prior art. On the other hand, the charging current can be increased as high as possible on the prerequisite of that the input voltage is not less than the preset reference voltage, so that a relatively higher charging efficiency can be achieved consequently.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method for controlling a charging current, adapted to a charging device, wherein the charging device receives an input voltage to thereby output the charging current, the method comprising steps of:
making the charging current have a first value;
judging whether the input voltage is less than a preset reference voltage; and
if the input voltage is judged to be less than the preset reference voltage, decreasing the charging current from the first value step by step until the input voltage retrieves back to be greater than the preset reference voltage.

2. The method as claimed in claim 1, further comprising a step of:
if the input voltage is judged to be not less than the preset reference voltage, maintaining the charging current at the first value.

3. The method as claimed in claim 1, wherein the step of making the charging current have a first value comprises:
making the charging current increase using a linear method from a second value to the first value.

4. The method as claimed in claim 1, wherein the step of making the charging current have a first value comprises:
making the charging current increase step by step from a second value to the first value.

5. A method for controlling a charging current, adapted to a charging device, wherein the charging device receives an input voltage to thereby output the charging current, the method comprising steps of:
making the charging current increase from an initial value step by step; and
after the charging current is increased with each step, judging whether the input voltage is less than a preset reference voltage, wherein:
if the input voltage is judged to be less than the preset reference voltage, making the charging current retrieve back to a previous value, and
if the input voltage is judged to be not less than the preset reference voltage, making the charging current continue increasing by step.

6. The method as claimed in claim 5, wherein the charging current increases by equal-steps.

7. A method for controlling a charging current, comprising steps of:
detecting a value of the charging current; and
when the detected value of the charging current is greater than a preset current value, outputting a pulse signal to control the charging current to decrease;
wherein, a pulse width of the pulse signal determines the decreased value of the charging current.

8. The method as claimed in claim 7, wherein the pulse signal controls the charging current to decrease step by step, and the pulse width of the pulse signal determines the decreased step amount of the charging current to thereby determine the decreased value of the charging current.
